(19) United States
(12) Patent Application Publication
(10) Pub. No.: US 2015/0252243 A1
(43) Pub. Date: Sep. 10, 2015

(54) USE OF SALTS OF POLYCARBOXYLATES WITH LIPOPHILIC INCREMENTS TO CONTROL SEPARATION IN CEMENT CONTAINING LATEX

(71) Applicant: TRICAN WELL SERVICE, LTD., Calgary (CA)

(72) Inventors: Conrad Ojong-Besong, Spring, TX (US); Frank Zamora, San Antonio, TX (US); Amanda Marentette, Kingwood, TX (US)

(73) Assignee: TRICAN WELL SERVICE, LTD., CALGARY (CA)

(21) Appl. No.: 14/640,720

(22) Filed: Mar. 6, 2015

Related U.S. Application Data
(60) Provisional application No. 61/949,202, filed on Mar. 6, 2014.

(51) Int. Cl. C09K 8/46; C09K 8/42; E21B 33/138

(52) U.S. Cl. CPC C09K 8/46; E21B 33/138; C09K 8/424

(57) ABSTRACT

Methods and compositions are provided that may comprise cement, a stabilizing additive, latex, and water. An embodiment of the present invention includes a method of cementing in a subterranean formation. The method may include introducing a cement composition into the subterranean formation, wherein the cement composition comprises cement, a stabilizing additive, latex, and water. Another embodiment of the present invention include a cement composition. The cement composition may comprise cement, a stabilizing additive, latex, and water.

### CROSS-REFERENCE TO RELATED APPLICATIONS

This application claims priority to U.S. Provisional Patent Application No. 61/949,202 that was filed on Mar. 6, 2014.

### FIELD OF INVENTION

Embodiments of the present invention generally relate to latex cement systems for downhole operation. More particularly, the invention relates to methods and apparatuses for controlling separation in cements incorporating latex.

### BACKGROUND

In cementing a well many cement compositions are commonly utilized. For instance, during drilling, a pipe string such as casing or liners may be run into a well bore and cemented in place using a cement. In a typical cementing operation, cement may be pumped into an annulus between the walls of the well bore and the exterior surface of the pipe string disposed therein. The cement sets in the annular space, forming an annular sheath of hardened, substantially impermeable cement that supports and positions the pipe string in the well bore and bonds the exterior surface of the pipe string to the subterranean formation. Among other things, the annular sheath of cement surrounding the pipe string functions to prevent the migration of fluids in the annulus, as well as protecting the pipe string from corrosion. Cement may also be used in remedial cementing methods, such as squeeze cementing and the placement of cement plugs.

In many instances, the cement in the annular space between the well bore and the pipe string often suffers structural failure due to pipe movements which cause shear stresses to be exerted on the set cement. Such stress conditions are commonly the result of relatively high fluid pressures and/or temperatures inside the cemented pipe string during testing, perforating, fluid injection or fluid production. High internal pipe pressure or temperature can result in the expansion of the pipe string, both radially and longitudinally, which places stresses on the cement sheath causing the cement bond between the exterior surfaces of the pipe or the well bore walls to fail and thus allow leakage of formation fluids and so forth. In such instances it may be desirable for the cement slurry used to cement a pipe string into the well bore to develop high strength after setting and to have sufficient resiliency (e.g., elasticity and ductility) to resist loss of the cement bond between the exterior surfaces of the pipe or the well bore walls, or both. Also, it may be desirable for the cement composition to be able to resist cracking and/or shattering that may result from other forces on the cement sheath. For example, it may be desirable for the cement sheath to include structural characteristics that protect its structural integrity from forces associated with formation shifting, overburden pressure, subsidence, tectonic creep, pipe movements, impacts and shocks subsequently generated by drilling and other well operations.

Typically latex has been included in cement compositions for use in subterranean formations to improve various properties of the compositions. The usual ratios of cement to latex, where the latex displaces a portion of the water, are anywhere from ½ gallon of latex per 94 pound bag of cement up to 2½ gallons of latex per 94 pound bag of cement.

Latex may be included in a cement composition for fluid loss control, to provide resiliency to the set cement, and/or to reduce the issues associated with gas channeling. In general, latex used in cement compositions may be provided as a water-in-oil emulsion containing high quantities of natural or synthetic rubber such as styrene-butadiene rubber. However there are temperature limitations to the latex slurries. Typically when using latex slurries at high temperatures, the viscosity of the latex cement slurry increases, increasing the amount of power required to pump the cement, in certain instances the viscosity of the cement may increase to the point where it will no longer pump at all, as well as reducing the ability of the cement to bond to the tubular and to the formation. Additionally, the styrene-butadiene may invert so that the styrene and butadiene disassociate allowing the cement precipitate out of the mixture leaving the styrene and butadiene segregated from the cement such that there are pockets of styrene, pockets of butadiene, and pockets of cement such that the cement job will not bond with the formation or the tubular and therefore will not seal the annular region between the pipe in the formation.

### SUMMARY

The present invention relates to an additive that tends to stabilize the latex cement slurry and allows the use of latex cement slurry when the temperature exceeds 350° F.

Typically the stabilizing additive is generally comprised of salts of polycarboxylates with lipophilic increments, such as copolymers of maleic acid and olefines, such as polyethylene, polypropylene or polyisobutylene. The water soluble and anionic polyelectrolytic nature of the invention, coats onto the latex particles to achieve a better dispersion and homogenous distribution in a slurry by a mechanism of electrostatic repulsion which then helps to prevent separation of particles and prevents separation of the latex-cement emulsion in high temperature environments.

The stabilizing additive also prevents particles settling in high pressure, high temperature spacers at temperatures exceeding 350° F. It uses the same mechanism as described above to prevent separation and fall-out of the high density material. It works well in suspending barite and other weighting agents in high density spacers having weights from about 14.5 pounds per gallon to about 18.5 pounds per gallon.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a graph of the viscosity of the latex cement slurry with the stabilizing additive as the temperature increases.

FIG. 2 depicts a graph of the viscosity of the latex cement slurry without the stabilizing additive as the temperature increases.

FIG. 3 depicts a graph of a second test of the viscosity of the latex cement slurry with the stabilizing additive as the temperature increases.

FIG. 4 depicts a picture of a cylinder of latex cement slurry with a stabilizing additive after being mixed and heated.

FIG. 5 depicts a picture of a cylinder of latex cement slurry without a stabilizing additive after being mixed and heated.

FIG. 6 depicts the results of a dynamic stability test of a latex cement slurry with a stabilizing additive after being mixed and heated.

FIG. 7 depicts the results of a dynamic stability test of a latex cement slurry without a stabilizing additive after being mixed and heated.

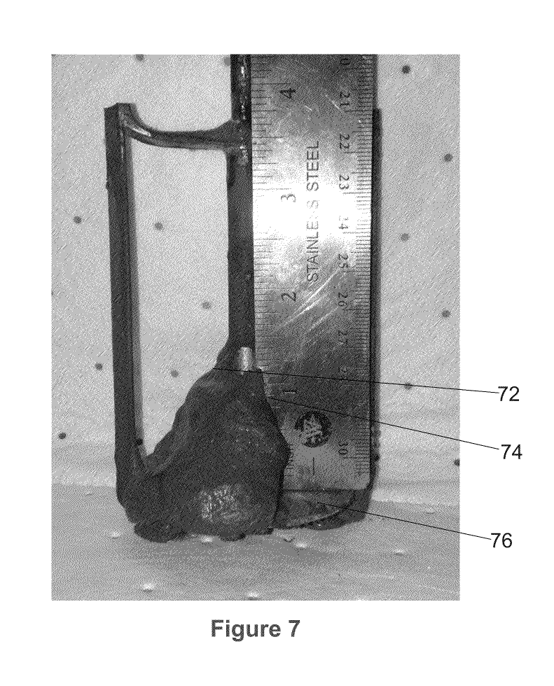

FIG. 8 depicts the results of a dynamic stability test of a spacer system with a stabilizing additive after being mixed and heated.

### DETAILED DESCRIPTION

The description that follows includes exemplary apparatus, methods, techniques, and instruction sequences that embody techniques of the inventive subject matter.

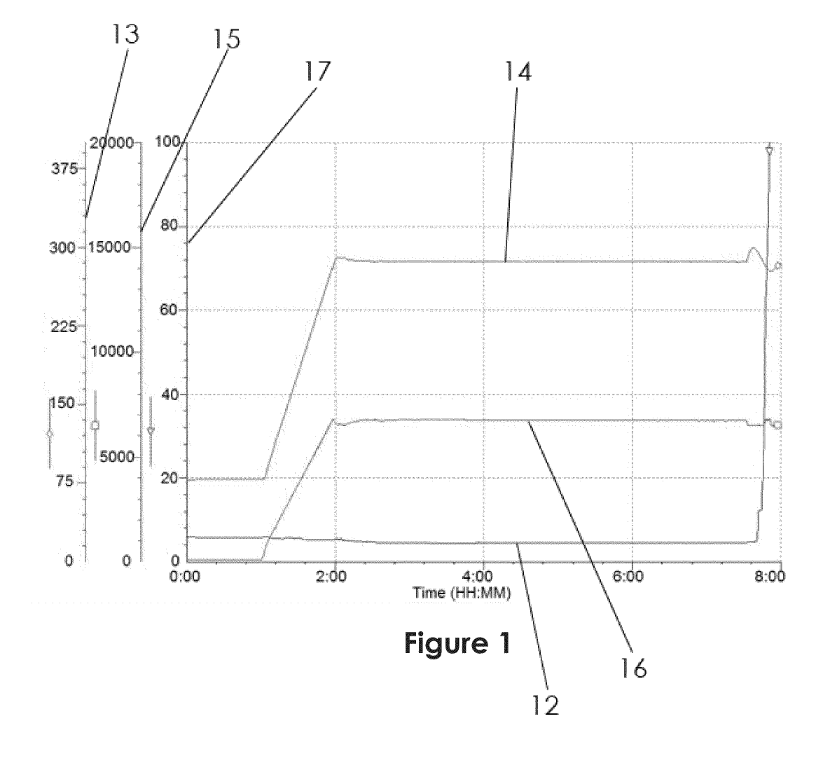

FIG. 1 depicts a graph of the consistency 12, in Bearden units corresponding to scale 17, of the latex cement slurry with the stabilizing additive as the temperature 14, corresponding to scale 13, and pressure 16, corresponding to scale 15, are increased. In this instance the latex cement slurry was created by adding 1 gallon of latex to a single 94 pound sack of portland cement. The latex was 65% styrene and 35% butadiene. The stabilizing additive, a salt of polycarboxylates with a lipophilic increment, was added in a ratio of about 0.4% of stabilizing additive to the cement slurry by weight. The stabilizing additive may be effective in ratios from as low as about 0.2% by weight of stabilizing additive to the cement slurry to as high as 2.5% by weight of stabilizing additive to the cement slurry. In practice ratios from about 0.5% to about 0.8% by weight of stabilizing additive to the cement slurry are better while the ratio of about 0.4% by weight of stabilizing additive to the cement slurry is preferred.

FIG. 1 shows us a latex cement slurry with the stabilizing additive after the slurry has been mixed but remains at about room temperature of about 75° F. After about an hour the pressure 16 and temperature 14 of the latex cement slurry was increased to about 6800 pounds per square inch (“PSI”) and to about 300° F. over a period of 1 hour. As can be seen the consistency 12 of the latex cement slurry remain constant until about 7 hours 45 minutes when the latex cement set thereby driving its consistency or viscosity 12 off the scale.

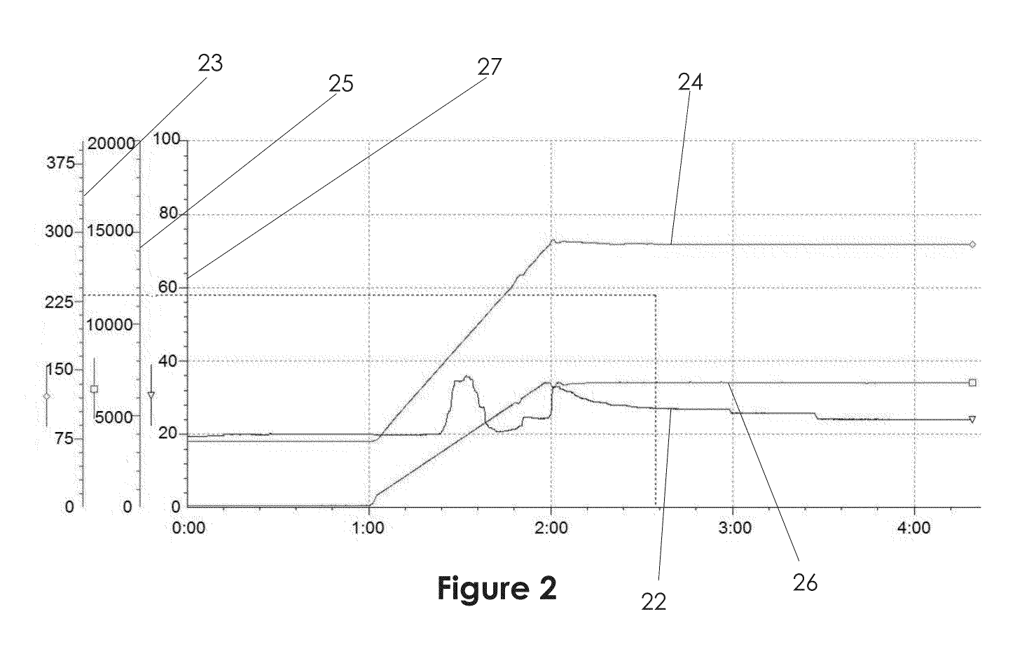

FIG. 2 depicts a graph of the consistency 22, in Bearden units, corresponding to scale 27 of the latex cement slurry without the stabilizing additive as the temperature 24, corresponding to scale 23, and pressure 26, corresponding to scale 25, are increased. FIG. 2 shows us a latex cement slurry without the stabilizing additive after the slurry has been mixed but remains at about room temperature of about 75° F. After about an hour the pressure 16 and temperature 14 of the latex cement slurry was increased to about 7000 PSI and to about 300° F. over a period of 1 hour. As can be seen the consistency 22 of the latex cement slurry becomes unstable at about 1 hour 24 minutes into the test or as the temperature reached about 150° due to the styrene butadiene rubber inverting.

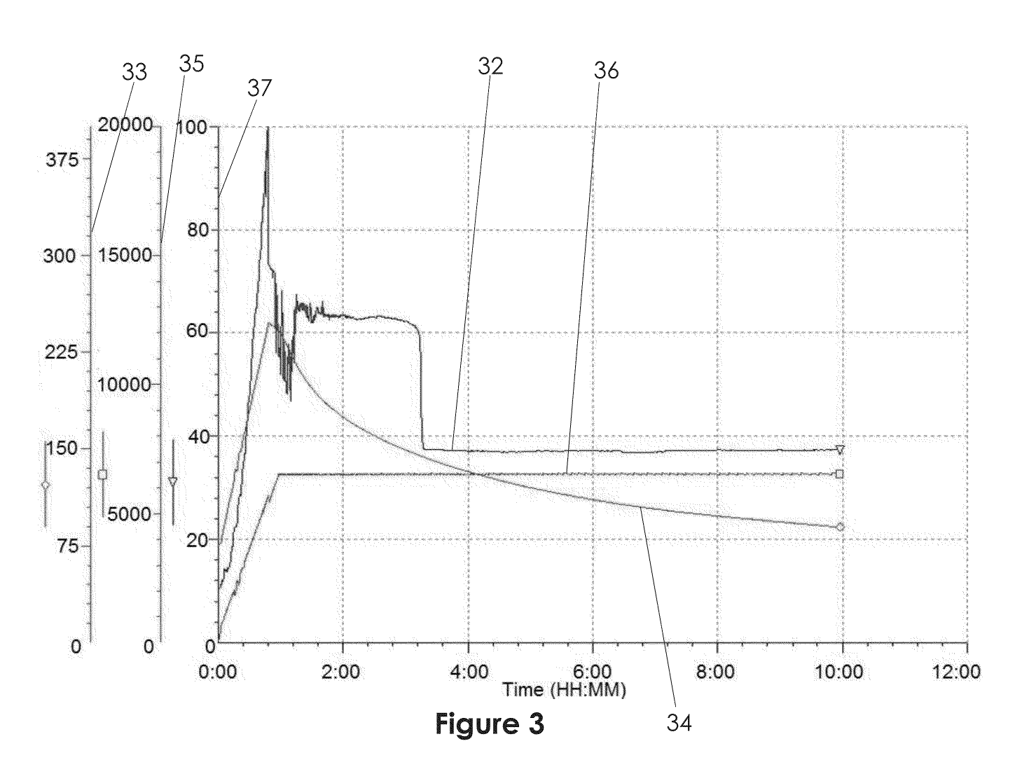

FIG. 3 depicts a graph of a second test of the consistency 32, in Bearden units, corresponding to scale 37, of the latex cement slurry without the stabilizing additive as the temperature 34, corresponding to scale 33, and pressure 36, corresponding to scale 35, are increased. FIG. 3 shows us a latex cement slurry without the stabilizing additive. In this instance almost as the temperature 34 began to approach 230° F. the consistency 32 of the latex cement slurry begins a dramatic rise becoming unstable within minutes. Once the latex cement slurry became unstable the latex cement slurry was allowed to cool to room temperature of about 75° F.

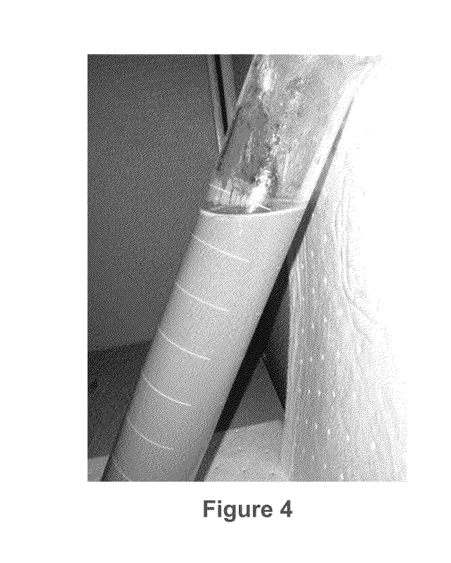

FIG. 4 is a picture of a graduated slurry containing a latex cement slurry with the stabilizing additive. The latex cement slurry has been subjected to a stability test where it was mixed with the stability additive and heated to 300° for 2 hours. The latex cement slurry with the stability additive was then cooled down and poured into a graduated cylinder and then placed in an oven at 180° F. until the cement either sets or the styrene butadiene rubber inverts. As can be seen in FIG. 4 the sample with the stabilizing additive did not invert.

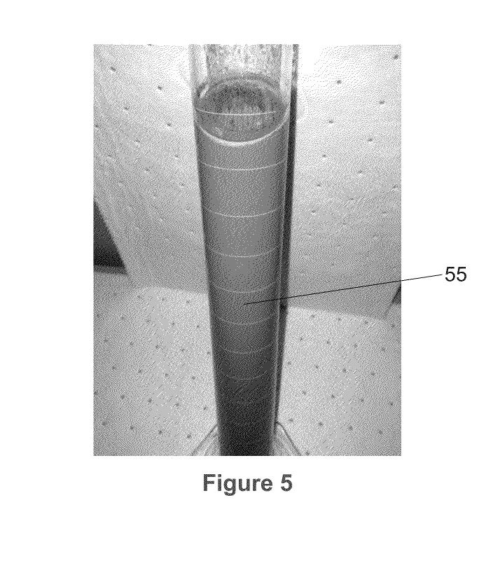

FIG. 5 is a picture of a graduated slurry containing a latex cement slurry without the stabilizing additive. The latex cement slurry has been subjected to the same stability test criteria as the sample in FIG. 4 where the latex cement slurry without the stabilizing additive was mixed and heated to 300° for 2 hours. The latex cement slurry without the stability additive was then cooled down and poured into a graduated cylinder and then placed in an oven at 180° F. until the cement either sets or the styrene butadiene rubber inverts. As can be seen in FIG. 5 the latex cement slurry has channeling 55 indicating that the styrene butadiene did invert.

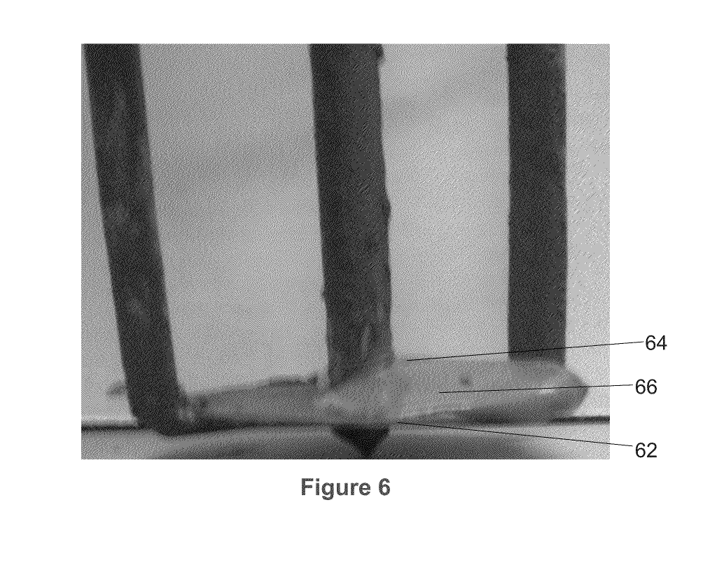

FIG. 6 is an image of the cone height obtained from the Dr. Beirute dynamic settling test where latex cement slurry with the stabilizing additive, after being mixed and heated to 300° F. for 2 hours then cooled, was tested. The dynamic settling test simulates the settling of solids in a downhole conditions. In the dynamic settling test the solids that remain on the top of the lower paddle blade 62, referred to as the cone height, are measured from the lower paddle blade to the top of the solids 64. A cone height of ½ inch in a cement slurry test indicates a failure meaning that solids that are settling out of the slurry. In FIG. 6 the latex cement slurry was created by adding 1 gallon of latex to a single 94 pound sack of portland cement. The latex was 65% styrene and 35% butadiene and 0.4% by weight of stabilizing additive was used. In this test the cone height was % inch thereby passing the test.

FIG. 6 is an image of the cone height obtained from the Dr. Beirute dynamic settling test where latex cement slurry without the stabilizing additive, after being mixed and heated to 300° F. for 2 hours then cooled, was tested. In this instance the cone height 72 is about 1¼ inches as indicated on the ruler 74 as measured from the bottom of the paddle 76. The cone height of 1¼ inch indicates a failure in that solids are settling out of the slurry. As before the latex cement slurry was created by adding 1 gallon of latex to a single 94 pound sack of portland cement. The latex was 65% styrene and 35% butadiene and 0.4% by weight of stabilizing additive was used.

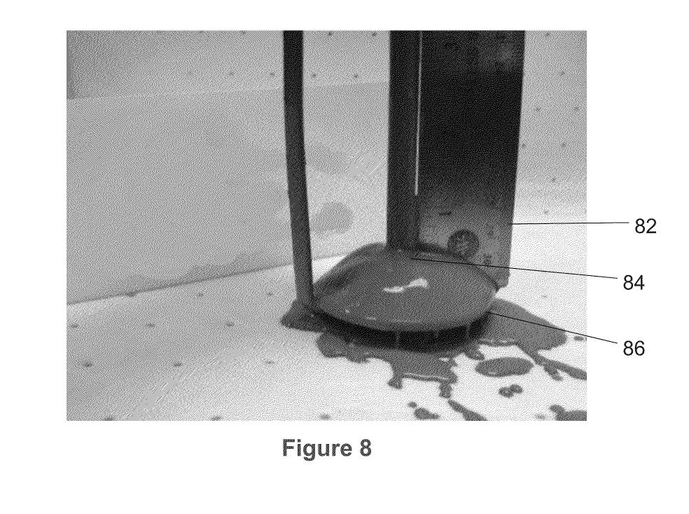

In many instances prior to pumping the latex cement slurry into the well a spacer is first pumped in order to separate the drilling mud or other fluids from the latex cement slurry. Typically the spacer is a mixture of a suspending agent such as a guar or an absorbent clay such as montmorillonite or bentonite, a high density material such as magnetite, hematite, or barite, water, and a surfactant. Typically such heavy weight spacers will have spacer density of from about 14.5 pounds per gallon to about 18.5 pounds per gallon. It has been found that the stabilizing additive preferably in an amount of about 1 pound of stabilizing additive per 42 gallons of spacer fluid. In practice it has been found that the use of about ½ pound to 3 pounds of stabilizing additive per 42 gallons of spacer fluid is effective to keep the high density material in suspension although using about ½ pound to 2 pounds of stabilizing additive per 42 gallons of stabilizing fluid is better at keeping the high density material in suspension. FIG. 8 shows a dynamic settling test of test spacer fluid having a density of about 16 pounds per gallon with a stabilizing additive added at a ratio of about 1 pound per 42 gallons of spacer fluid. A cone height of 1.0 inches or greater in a spacer test indicates a failure meaning that solids that are settling out of the slurry. In this instance the cone height 84 is about ½ inches as indicated on the ruler 82 as measured from the bottom of the paddle 86. The cone height of ½ indicates a spacer that passes such that solids are not settling out of the slurry at too rapid a rate.

Bottom, lower, or downward denotes the end of the well or device away from the surface, including movement away from the surface. Top, upwards, raised, or higher denotes the end of the well or the device towards the surface, including movement towards the surface. While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

While the foregoing is directed to embodiments of the present invention, other and further embodiments of the invention may be devised without departing from the basic scope thereof, and the scope thereof is determined by the claims that follow.

What is claimed is:

1. A cement slurry comprising:
a cement composition,
a latex, and
a stabilizing agent.

2. The cement slurry of claim 1, wherein the latex is styrene-butadiene rubber.

3. The cement slurry of claim 1, wherein the stabilizing agent is a salt of a polycarboxylate having a lipophilic increment.

4. The cement slurry of claim 3, wherein the lipophilic increment is a copolymer of maleic acid and olefin.

5. The cement slurry of claim 4, wherein the copolymer of maleic acid and olefin is polyethylene.

6. The cement slurry of claim 4, wherein the copolymer of maleic acid and olefin is polypropylene.

7. The cement slurry of claim 4, wherein the copolymer of maleic acid and olefin is polyisobutylene.

8. The cement slurry of claim 1, wherein the stabilizing agent is from 0.2% to 2.5% by weight of stabilizing agent to cement slurry.

9. The cement slurry of claim 1, wherein the stabilizing agent is from 0.% to 0.8% by weight of stabilizing agent to cement slurry.

10. A method of cementing a well comprising:
preparing a cement slurry, wherein the cement slurry is a cement composition and a latex,
mixing a stabilizing agent with the cement slurry,
pumping the cement slurry and stabilizing agent into a well wherein the temperature of the well is at least 300° F.

11. The method of cementing a well of claim 10, wherein the temperature of the well is at least 350° F.

12. The method of cementing a well of claim 10, wherein the latex is styrene-butadiene rubber.

13. The method of cementing a well of claim 10, wherein the stabilizing agent is a salt of a polycarboxylate having a lipophilic increment.

14. The method of cementing a well of claim 13, wherein the lipophilic increment is a copolymer of maleic acid and olefin.

15. The method of cementing a well of claim 14, wherein the copolymer of maleic acid and olefin is polyethylene.

16. The method of cementing a well of claim 14, wherein the copolymer of maleic acid and olefin is polypropylene.

17. The method of cementing a well of claim 14, wherein the copolymer of maleic acid and olefin is polyisobutylene.

18. The method of cementing a well of claim 10, wherein the stabilizing agent is from 0.2% to 2.5% by weight of stabilizing agent to cement slurry.

19. The method of cementing a well of claim 10, wherein the stabilizing agent is from 0.% to 0.8% by weight of stabilizing agent to cement slurry.

20. A spacer comprising:
a spacer, and
a stabilizing agent, wherein the stabilizing agent is a salt of a polycarboxylate having a lipophilic increment.

21. The spacer of claim 20, wherein the spacer has a density from about 14.5 pounds per gallon to about 18.5 pounds per gallon.

22. The spacer of claim 20, wherein the spacer includes a suspending agent, a high density material, water, and a surfactant.

23. The spacer of claim 22, wherein the suspending agent is a guar.

24. The spacer of claim 22, wherein the suspending agent is an absorbent clay.

25. The spacer of claim 22, wherein the high density material is magnetite.

26. The spacer of claim 22, wherein the high density material is hematite.

27. The spacer of claim 22, wherein the high density material is barite.

28. The spacer of claim 22, wherein the lipophilic increment is a copolymer of maleic acid and olefin.

29. The spacer of claim 28, wherein the copolymer of maleic acid and olefin is polyethylene.

30. The spacer of claim 28, wherein the copolymer of maleic acid and olefin is polypropylene.

31. The spacer of claim 28, wherein the copolymer of maleic acid and olefin is polyisobutylene.

32. The spacer of claim 22, wherein the stabilizing agent is from 0.5 pounds to about 3.0 pounds of stabilizing additive per 42 gallons of spacer.
